(19) United States
(12) Patent Application Publication
(10) Pub. No.: US 2010/0212176 A1
(43) Pub. Date: Aug. 26, 2010

(54) Tumble Dryer With Peltier Heat Pump

(75) Inventors: Harald Moschütz, GroBbeeren (DE); Ingo Schulze, Panketal (DE); Andreas Stolze, Falkensee (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munchen (DE)

(21) Appl. No.: 12/086,802

(22) PCT Filed: Nov. 30, 2006
(86) PCT No.: PCT/EP2006/069120

§ 371 Date: Feb. 25, 2010

(30) Foreign Application Priority Data
Dec. 19, 2005 (DE) 10 2005 060 673.3

(51) Int. Cl. F26B 21/06; F25B 21/02

(52) U.S. Cl. 34/73; 62/3.3

(57) ABSTRACT

A tumble dryer including a heat pump that includes a Peltier module having a plurality of Peltier elements operationally associated therewith and wherein the Peltier module has a cold side and a warm side; at least two air-directing ducts including a first duct in fluid communication with the Peltier module cool side through which cooling air is directed for cooling and dehumidifying; and a second duct in fluid communication with the Peltier module warm side through which dried air is directed for reheating; and an air and water vapor permeable filter disposed in the second duct facing the Peltier elements. Moisture which arises on the Peltier elements can thereby escape into the duct.

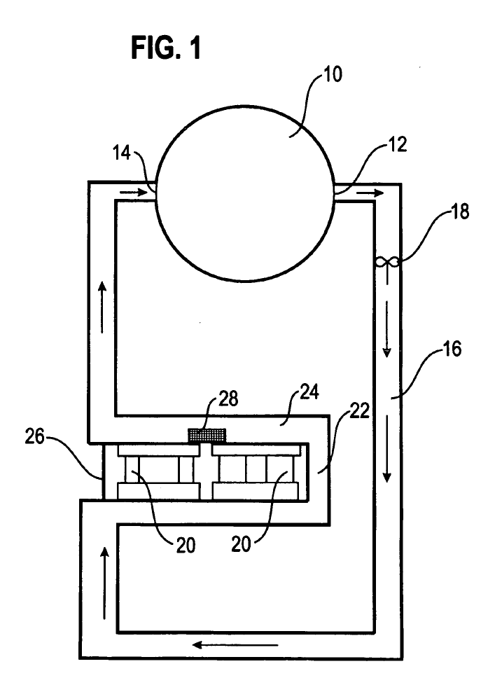

The invention relates to a tumble dryer with a Peltier heat pump as claimed in the preamble of claim 1.

Such a tumble dryer is known from DE 69 26 182 U for instance.

A commercially available Peltier element in terms of design and function is known from a document which was downloadable from the internet address http://de.wikipedia.org/wiki/Petier-Element on Nov. 25, 2005. The half elements of this Peltier element are pillar- or block-shaped and consist of doped semiconductors as materials. The semiconductors are in particular bismuth telluride and p-conductively doped and n-conductively doped semiconductors are used. A half element consisting of the p-conductively doped semiconductor and a half element consisting of the n-conductively doped semiconductor are each connected to one another on one side by way of a printed circuit board, also known as a metal bridge and on another side, which is opposite to the said side, by way of an additional printed circuit board in each instance having an additional half element or a terminal contact in order to connect the Peltier element to an electrical network.

Further details with regard to the basics, user-related selection and assembly of Peltier elements may be derived from the documents which were downloadable from the internet addresses http://www.quick-ohm.de/waerme/download/Erlaeuterung-zu-Peltierelementen.pdf and http://www.quick-ohm.de/waerme/download/Einbau.pdf on Nov. 25, 2005.

DE 1 410 206 A discloses a washing machine, in which laundry can not only be washed but also dried. The publication indicates several alternatives for the additional apparatuses required herefor; in particular provision can be made for an electrical heating device for heating an air flow used to dry laundry and for a simple heat exchanger for cooling down the heated air flow once the laundry has been loaded, the heater and the cooling system can however also form part of a heat pump apparatus. The heat pump apparatus may be a heat pump apparatus which operates with Peltier elements in order to utilize the thermoelectric effect.

A device emanating from an English extract belonging to JP 08 057 194 A in the data collection “Patent Abstracts of Japan” for drying laundry, which in turn corresponds to the version described in the introduction, contains in its first channel system, in addition to a warm side and a cold side, which both form part of a thermoelectrically operable heat pump apparatus, an additional heat exchanger which is arranged upstream of the cold side for cooling the air flow dissipated from the laundry and an additional heating apparatus arranged downstream of the warm side for additionally heating the air flow before loading the laundry.

A Peltier element module in a corresponding heat pump apparatus has a cold side and a warm side. Air for cooling and dehumidifying is guided past the cold side in a tube. The air thus dried for reheating is guided past the warm side in a tube.

Moisture which is condensed out on the cold side is usually collected in a container. The tube which is guided past the cold side is frequently covered with a water film at least on the side which is directly connected to the cold side. The Peltier elements are positioned across the tube. However, moisture can frequently penetrate the Peltier elements. Silicon covers can only change this to a limited degree. Holes in the heat conducting elements upon which the Peltier elements are arranged are particularly critical. Such holes are frequently required for screw connections.

Water on a Peltier element can result in corrosion and even in a short circuit or ground fault and can thus effect the failure of the entire Peltier element module.

It is one object of the invention to develop a tumble dryer as claimed in the preamble of claim 1 such that a disadvantageous influx of water, which reaches the Peltier element module, is prevented.

The object is achieved in accordance with the invention by the features of claim 1.

In accordance with the invention, a filter which is permeable to air and water vapor is arranged in the tube which runs along the warm side of the module (in other words, is guided therepast) and faces the Peltier elements.

This filter represents a connection between the space in which the Peltier elements are arranged, and the warm side of the Peltier module, where a minimum partial pressure of water vapor is present in any case in the region of the Peltier module, said connection being effective for transporting water. As a result of the filter, this minimum partial pressure also adjusts to the Peltier elements and any surplus water, which may have accumulated there, is transported out through the filter to the warm side. Unwanted moisture thus leaks out of the Peltier elements into the tube.

In other words, the Peltier elements are vented from now on by selecting a suitable filter and are at the same time actively dehumidified from the warm side. As a result, the sealing outlay is reduced during the production of the modules and the overall quality of the heat pump is improved.

The filter is preferably impermeable to a liquid like water, so as to prevent liquid water from penetrating in any case from the warm side.

A filter made of polytetrafluorethylene is particularly suitable as a filter, e.g. made of expanded polytetrafluorethylene, as is marketed by the company Gore & Ass.

The Peltier elements are preferably arranged in an internal chamber of the Peltier module which is delimited by walls, and the filter creates an air and water vapor-permeable connection from the tube to the internal chamber (and thus also from the internal chamber to the tube). The adequate ventilation of the internal chamber of the Peltier element module prevents pressure fluctuations and potentially arising moisture can evaporate out of the interior of the module as a result of the drop in water vapor partial pressure.

A preferred embodiment of the invention is now described with reference to the drawing, in which the;

FIGURE shows a schematic representation of the design of a tumble dryer.

The laundry is disposed in a laundry drum 10 in the tumble dryer. The laundry drum 10 has an outlet 12 and an inlet 14 for air. The air from the outlet 12 firstly reaches the tube 16, into which it is sucked with the aid of a pump 18, with the tube being guided toward the cold side (right in the image) of a Peltier element module consisting of Peltier elements 20. The water condenses out of the air on the cold side of the Peltier element module, said air having received this water from the laundry in the drum 10, and is collected in a container (not shown). The dried air is now fed through tube 22 into tube 24, which connects the warm side of the Peltier element module to the inlet 14 of the drum 10. The dried air is heated there so that it reaches the inlet 14 as warm air in order once again to be able to dry laundry in the drum 10.

It should be noted that the air guide shown in the FIGURE is only a schematic representation of a real guide, according to which the Peltier elements 20 shown in the FIGURE have to be coated with air one after the other, firstly on the respective cold side, then on the respective warm side. To this end, the real guide is to be designed as an S-shaped loop, which is guided past the Peltier elements 20 twice as described.

In accordance with the preferred embodiment shown here, the Peltier element module is outwardly sealed by means of walls 26, with the tubes 16 and 24 each forming the seal laterally in the image.

A filter 28 is provided in order to prevent liquid from penetrating between the walls 26 in the internal chamber of the Peltier element module out from the Peltier elements 20, and thus negatively affecting the Peltier elements 20, said filter being arranged in the tube 24 and creating a connection from the interior of the tube 24 to the interior of the Peltier element module. The filter 28 shown schematically here is arranged at a point where it has the least negative effect on the warming up of air in the tube 24 on the warm side of the Peltier element module and connects the interior of the Peltier element module to a position in the tube 24, at which a minimum partial pressure of water vapor prevails. The filter 28, which is produced from expanded polytetrafluorethylene, which is air and water vapor permeable, but impermeable to liquids, can if necessary evaporate liquid arising in the internal chamber of the Peltier element module between the walls 26, for instance through leakages in the tube 16 on the cold side, and said liquid can reach the tube 24 via the filter 28 and thus leave the interior of the Peltier element module again.

The previously used concept of sealing the Peltier element module using silicon or such like is thus superseded. Instead, a suitable connection between the interior of the Peltier element module and the tube 24 is purposefully created, by means of which any liquid can leave the Peltier element module by way of the filter 28.

This is therefore a ventilated Peltier element module.

1-4. (canceled)

5. A tumble dryer comprising:
a heat pump that includes a Peltier module having a plurality of Peltier elements operationally associated therewith and wherein the Peltier module has a cool side and a warm side;
at least two air-directing ducts including a first duct in fluid communication with the Peltier module cool side through which cooling air is directed for cooling and dehumidifying; and a second duct in fluid communication with the Peltier module warm side through which dried air is directed for reheating; and
an air and water vapor permeable filter disposed in the second duct facing the Peltier elements.

6. The tumble dryer according to claim 5 wherein the filter is impermeable to liquid.

7. The tumble dryer according to claim 5 wherein the filter is formed from polytetrafluorethylene.

8. The tumble dryer according to claim 5 wherein the filter is formed from expanded polytetrafluorethylene.

9. The tumble dryer according to claim 5 wherein the Peltier module includes a at least one wall defining an inner chamber with the Peltier elements being disposed in the inner chamber of the Peltier module and wherein the filter forms an air and water vapor permeable connection from the second duct to the inner chamber.
